(19) United States
(12) Patent Application Publication
(10) Pub. No.: US 2026/0195288 A1
(43) Pub. Date: Jul. 9, 2026

(54) HIGH SECURITY GRADE CONTROL DEVICE FOR POWER GENERATOR

(71) Applicant: Woori Technologies Corporation, Seoul (KR)

(72) Inventors: HO JUN SIM, Seoul (KR); JUNHEE LEE, Seoul (KR)

(73) Assignee: Woori Technologies Corporation, Seoul (KR)

(21) Appl. No.: 19/011,602

(22) Filed: Jan. 7, 2025

(51) Int. Cl. G06F 13/42

(52) U.S. Cl. CPC G06F 13/4282; G06F 2213/0042

(57) ABSTRACT

Disclosed is a technology for system configuration of a high security grade control device. A configuration memory storing system configuration information is hardware-blocked from write access by a main controller of the control device. A separate access control circuit processes configuration data write-requests from an external terminal after performing security authentication. The security authentication may be processed using only internal information without external communication.

### BACKGROUND

### 1. Field

Disclosed is a technology for system configuration of a control device, particularly a technology relating to system configuration of a high security grade control device.

### 2. Description of Related Art

In this specification, system configuration information of a control device may include, for example, security information for accessing major system elements and communication port configuration information. Usually, access to such system configuration information is restricted because unauthorized changes may incur security issues. FIG. 1 illustrates an example of a system that manages change of system configuration information in a conventional control device. An external terminal 30 is connected to a control device 10. These two devices can be connected through wired interfaces such as USB ports or serial communication ports, or wireless interfaces such as Bluetooth. A system configuration program running on the external terminal 30 connects to a security server 50 through a public network 70 for authentication before allowed to connect to the control device 10. However, for control devices having high security grades, such as controllers for nuclear power plant or wind turbine, connection of the connected external terminal to a public network may pose serious security risks.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The following description is directed to providing a system configuration technology for a control device having high security grades.

The following description is also directed to providing a control device having a function that supports system configuration without external connection.

The following description is further directed to providing a control device in which changes to system configuration can be blocked even if the software of the main controller becomes infected by external intrusion.

According to one aspect of the present invention, a control device is provided in which writing to a configuration memory from a main controller is hardware-blocked. A separate access control circuit is configured to process a configuration data write request from an external terminal after performing security authentication. The security authentication may be processed using only internal information without external communication. As a result, hardware-based configuration memory access management may block changes to configuration information by software that becomes infected with external attacks within the control device.

### BRIEF DESCRIPTION OF THE DRAWINGS

FIG. 1 is a diagram illustrating an example of a system for changing system configuration information in a conventional control device.

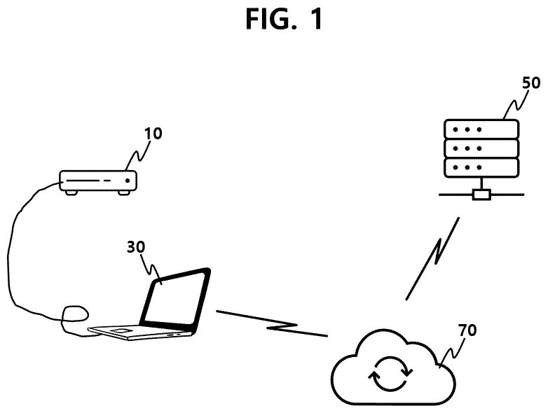

FIG. 2 is a block diagram illustrating a configuration of a high security grade control device according to an embodiment of the present invention.

FIG. 3 is a state diagram illustrating operations of the external access control circuit.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The aforementioned and additional aspects will be described in detail through exemplary embodiments described with reference to the accompanying drawings. It is understood that components of each embodiment may be combined in various ways within the embodiment or with components of other embodiments unless otherwise mentioned or contradictory. Based on the principle that an inventor may appropriately define the concepts of terms to best describe their invention, the terms used in this specification and claims should be interpreted with meanings and concepts that correspond to the content or proposed technical idea.

In this specification, blocks expressed as ‘circuits’ or ‘units’ in block diagrams may be implemented in hardware or as parts thereof, such as dedicated semiconductors, gate arrays, FPGAs. Multiple blocks may be merged into a single hardware circuit. As another example, some of these blocks may be implemented as an information processing device having a configuration where a computing element executes program instructions stored in a memory element. Multiple blocks may be implemented as parts of a single program executed in a computing element. As yet another example, some of these blocks may be implemented in a hybrid form where some parts are dedicated circuits and other parts are software. Furthermore, in software implementation, the computing element may include or combine, to the extent possible, digital signal processors, computation-dedicated processors, artificial intelligence processing engines, artificial intelligence-dedicated processors, and graphics processors.

Detailed embodiments of the present invention will now be described with reference to the accompanying drawings.

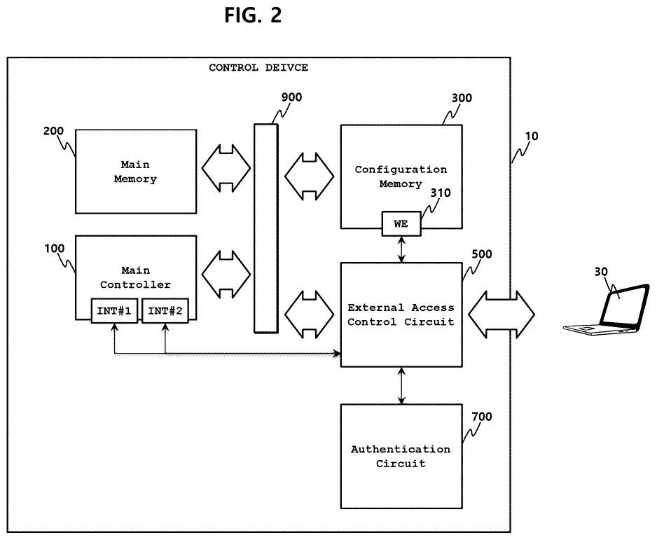

FIG. 2 is a block diagram illustrating a configuration of a high security grade control device according to an embodiment. As shown, the control device according to the embodiment includes a main controller 100, a bus 900 connected to the main controller 100, a configuration memory 300, an authentication circuit 700, and an external access control circuit 500.

The main controller 100 may be implemented with one or more microprocessors. Additionally, it may include one or more dedicated computation processors. The bus 900 may include a separate bus controller and serves as a pathway for data signals and address signals between components within the device.

Programs and data executed by the main controller 100 are stored in a main memory 200. The main memory 200 may have a hierarchical structure including, for example, SRAM (Static Random Access Memory) and/or DRAM (Dynamic Random Access Memory), and auxiliary storage devices such as SSD (Solid State Disk).

The configuration memory 300 stores configuration data and is connected to the bus 900, but its write control input 310 is not connected to the main controller 100. The configuration memory 300 may be implemented as non-volatile memory such as flash memory. Memory typically has a write control input pin (/WE) and a read control input pin (/RE). To write data to memory, an address is output to the address bus and data is output to the data bus, then activating the write control input causes the data to be written to that address at one edge of the write control input. While the configuration memory 300 has its address pins and data pinss connected to the bus 900, its write control input pin is not connected to the main controller 100, thereby blocking the main controller 100 from writing or changing configuration data stored in the configuration memory 300.

The authentication circuit 700 processes security authentication without external communication. In one embodiment, the authentication circuit 700 may be implemented with logic circuits. In one embodiment, the authentication circuit processes security authentication through security parameter input. An encrypted security parameter is stored within the authentication circuit 700, and encryption circuits may be implemented as part of the authentication circuit 700. In another embodiment, the authentication circuit processes security authentication by comparing a MAC of the external terminal 30 with registered MAC information. MAC addresses of authorized external terminals 30 are registered within the authentication circuit 700.

The external access control circuit 500 is connected to the write control input 310 of the configuration memory 300 and to the bus 900. The external access control circuit 500 authenticates the external terminal 30 through the authentication circuit 700 in response to a configuration change request related to system security elements from the external terminal 30. Subsequently, the external access control circuit 500 requests bus control authority from the main controller 100. In one embodiment, the external access control circuit 500 requests bus control authority from the main controller through a hardware interrupt. In the illustrated embodiment, the external access control circuit 500 requests a hardware interrupt through the INT #1 pin of the main controller. In one embodiment, when this hardware interrupt occurs, the main controller 200 may transfer control to a backup controller and suspend program execution. After requesting the hardware interrupt and following a certain delay, the external access control circuit 500 writes changed system security element-related configuration data to the configuration memory 300 via the bus 900.

Additionally, the external access control circuit 500 may notify the main controller 100 of the return of bus control authority after writing the changed configuration data. At this time, the external access control circuit 500 may notify the main controller 100 of the return of bus control authority via another hardware interrupt. In the illustrated embodiment, the external access control circuit 500 notifies the return of bus control authority through a hardware interrupt to the INT #2 pin of the main controller. Accordingly, when this hardware interrupt occurs, the main controller 200 may recover and resume the control that was transferred to the backup controller.

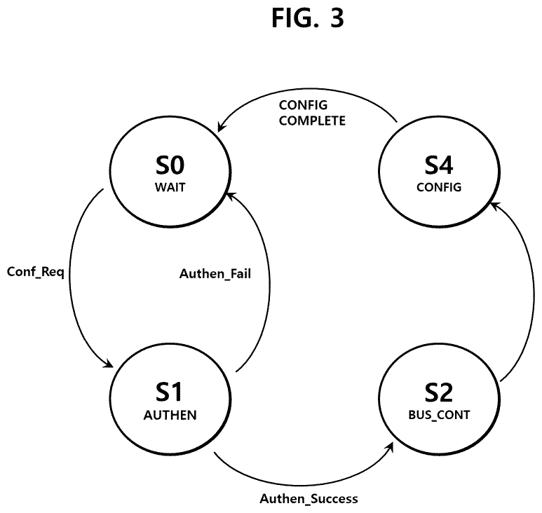

In the illustrated embodiment, the external access control circuit 500 may be implemented as a logic circuit designed by a finite-state machine. FIG. 3 is a state diagram illustrating operations of the external access control circuit. From state S0 (WAIT), it transitions to state S1 (AUTHEN) in response to a configuration request from the external terminal. If authentication fails in S1, it returns to state S0 and waits agiain. Upon successful authentication, it transitions to state S2 (BUS_CONT) to obtain bus control authority. After requesting through a hardware interrupt and following a certain delay, it transitions to state S4 (CONFIG) to write the changed configuration data. Subsequently, it returns the bus control authority and returns to the initial state S0 to wait.

While the present disclosure has been described above with respect to embodiments in conjunction with the accompanying drawings, the present disclosure is not limited thereto and should be interpreted to cover various modifications that will be apparent to those of ordinary skill in the art. The claims are intended to cover such modifications.

What is claimed is:

1. A high security grade control device comprising:
a main controller;
a bus connected to the main controller;
a configuration memory that stores configuration data, which is connected to the bus but whose write control input is not connected to the main controller;
an authentication circuit that processes security authentication without external communication; and
an external access control circuit which is connected to the write control input of the configuration memory and to the bus, authenticates the external terminal through the authentication circuit in response to a configuration change request related to system security elements from an external terminal, subsequently requests bus control authority from the main controller, and thereafter writes changed system security element-related configuration data to the configuration memory via the bus.

2. The high security grade control device of claim 1, wherein the external access control circuit requests the bus control authority via a hardware interrupt to the main controller.

3. The high security grade control device of claim 1, wherein the external access control circuit notifies the main controller of the return of bus control authority additionally after writing the changed configuration data.

4. The high security grade control device of claim 3, wherein the external access control circuit notifies the main controller of the return of bus control authority via another hardware interrupt.

5. The high security grade control device of claim 1, wherein the authentication circuit processes security authentication through security paramter input.

6. The high security grade control device of claim 1, wherein the authentication circuit processes security authentication by comparing a MAC of the external terminal with registered MAC information.
